(19) United States
(12) Patent Application Publication
(10) Pub. No.: US 2009/0063507 A1
(43) Pub. Date: Mar. 5, 2009

(54) METHODS AND APPARATUS FOR RETRIEVING CONTENT

(76) Inventor: MARK THOMPSON, Tempe, AZ (US)

Correspondence Address: THE NOBLITT GROUP, PLLC, 4800 NORTH SCOTTSDALE ROAD, SUITE 6000, SCOTTSDALE, AZ, 85251, US

(21) Appl. No.: 12/144,421

(22) Filed: Jun. 23, 2008

Related U.S. Application Data
(60) Provisional application No. 60/945,788, filed on Jun. 22, 2007.

(51) Int. Cl. G06F 17/30

(52) U.S. Cl. 707/10; 707/E17.01

(57) ABSTRACT

Method and apparatus for retrieving content according to various aspects of the present invention operate in conjunction with systems for transferring data in a p2p network connecting multiple clients. Exemplary methods and apparatus may generate a catalog of multiple file segments stored in a memory accessible by computer and publish the catalog for access by the clients.

### BACKGROUND OF INVENTION

As increasing volumes of data are transmitted via various electronic networks, the performance capacities of those networks must similarly increase to ensure satisfactory user experiences. Although performance of a network may be improved by making substantial modifications to the hardware devices that control and transmit information through the network, such a solution, alone, may not be optimal. The acquisition and installation of upgraded hardware tends to be an extremely expensive and time-consuming activity.

Most computer systems utilize two or more memory systems during operation. The memory systems may include short-term high-performance data storage systems and long-term low-performance data storage systems. For example, a computer or server may use a combination of processor registers, on-die cache, RAM, and hard-drive memory systems during operation. Other memory systems include flash drives, CD, DVD and HD-DVD drives, tape storage systems and network storage devices.

All memory systems exhibit varying performance, cost and capacity characteristics. Usually, performance and capacity must be sacrificed in exchange for lower cost components. Accordingly, most computers and servers utilize a combination of memory systems to provide reasonable performance at reasonable cost. The various memory systems may be categorized as primary storage, secondary and off-line storage, tertiary storage and network storage.

Primary storage includes those memory systems that provide extremely high performance connected directly to a processing unit. Primary storage is usually volatile meaning that when it loses power, data stored within the system is lost. Primary storage systems include processor caches and RAM memory.

Secondary and off-line storage systems provide much greater capacity than primary storage systems and are also non-volatile—they retain data even after losing power. However, secondary and off-line storage systems provide much lower performance than primary storage systems, sometimes accessing data as much as a million times slower than primary storage. Secondary storage systems include hard-disk drives and flash memory drives.

Tertiary and database storage systems are used for storing large amounts of data. In exchange for the large storage capacity, these systems tend to be expensive and provide lower performance than primary or secondary storage systems. Tertiary storage systems may include a mechanical unit that physically retrieves off-line mass-storage media to make it accessible to a client.

Finally, network storage systems include those storage systems and combinations of storage systems that are connected to a computer or server via a network connection.

As a computer or server operates, it may use any combination of the described memory systems to perform tasks. At any moment, a computer or server may have data segments of many different files occupying one or more data storage system.

Peer-to-peer (p2p) networks have been developed to facilitate the distribution of content via networks. P2p networks use the bandwidth and computing power of the clients of the p2p network to distribute files rather than rely upon a single web server or collection of servers. P2p networks operate by splitting a large file into multiple file segments. Those file segments are then distributed amongst the clients of the p2p network. When a new client joins the p2p network, that client may begin retrieving file segments from the other p2p clients, rather than from a single web server. As a result, large files can be transferred more easily between clients of the p2p network.

### BRIEF DESCRIPTION OF THE DRAWING FIGURES

Representative elements, operational features, applications and/or advantages of the present invention reside in the details of construction and operation as more fully described or otherwise identified. The description may refer to the accompanying drawings, images, figures, etc., wherein like numerals (if any) refer to like parts throughout. Elements, operational features, applications and/or advantages are illustrated by certain exemplary embodiments recited in the disclosure.

FIG. 1 is a block diagram of a system for retrieving content according to various aspects of the present invention;

FIG. 2 is a flow diagram of a method for retrieving content according to various aspects of the present invention;

FIG. 3 is a flow diagram of a method for retrieving content according to various aspects of the present invention; and

FIG. 4 is a flow diagram of a method for retrieving content according to various aspects of the present invention.

Elements and steps in the figures are illustrated for simplicity and clarity and have not necessarily been rendered drawn to scale or according to any particular sequence. For example, steps that may be performed concurrently or in a different order are illustrated in the figures to help to improve understanding of embodiments of the present invention. Likewise, the dimensions of some of the elements in the figures may be exaggerated relative to other elements to help improve understanding of various embodiments of the present invention.

### DETAILED DESCRIPTION OF EXEMPLARY EMBODIMENTS

The present descriptions relate to exemplary embodiments of the invention and the inventor's conception of the best mode and are not intended to limit the scope, applicability or configuration of the invention in any way. Rather, the following description is intended to provide convenient illustrations for implementing various embodiments of the invention. Changes may be made in the function and/or arrangement of the elements described in the disclosed exemplary embodiments without departing from the spirit and scope of the invention.

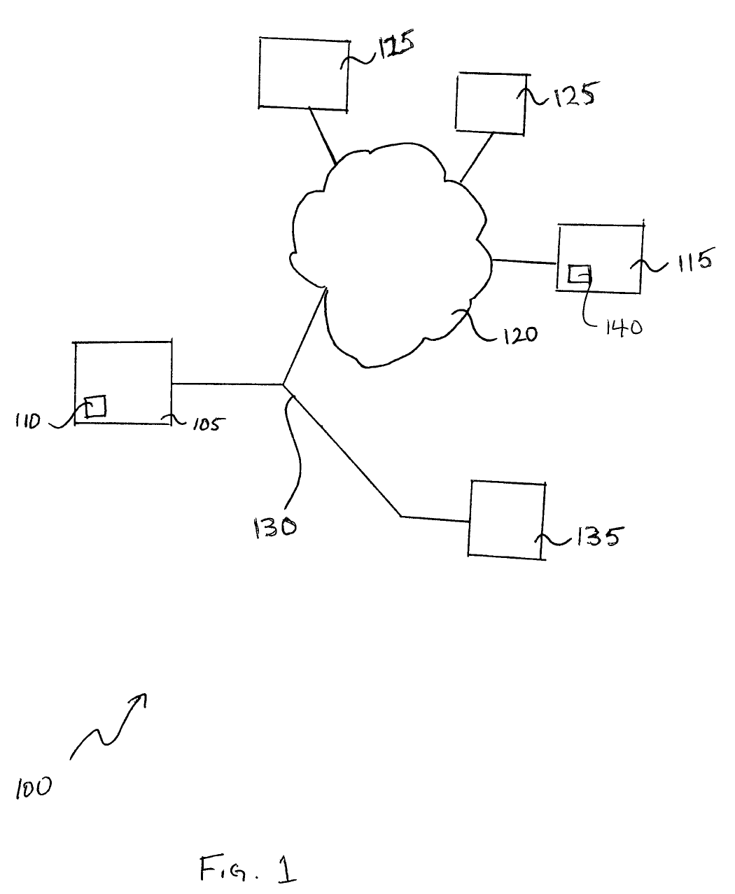

Referring to FIG. 1, a data transfer system 100 for retrieving content according to various aspects of the present invention may include multiple computers exchanging data. For example, the present exemplary data transfer system 100 for retrieving content includes a client 105 connected to one or more file servers 115. Data is transferred between the client 105 and file servers 115 via the communications medium 130. In the present embodiment, the communications medium includes a p2p network 120 to facilitate the exchange of data between various p2p clients 125.

The client 105 receives, stores, and/or transmits information via the communications medium 130. The client 105 may comprise any system for communicating via a network or the communications medium 130. For example, the client 105 may be a conventional computer having a processor and a storage mechanism, such as RAM, hard drives, CD-ROM drives and disks, HD-DVD drives and disks, or other appropriate volatile or non-volatile memory system. Alternatively, the client 105 may be a television, stereo, radio, PDA, telephone, personal media player, or other device that receives digital or analog data.

In the present embodiment, the client 105 may execute software applications for requesting and providing information via the medium 130. The client 105 of the present embodiment comprises a conventional computer system that runs an operating system, such as Microsoft Windows, Mac OSX, or Linux, and may execute software and connect to a network. The client 105 connects to the network in any manner, including a network cable connection or a wireless connection. Also, the client 105 may communicate through the network using any appropriate communication protocols, such as TCP/IP, UDP, etc.

The client 105 of the present embodiment operates a client application 110 to request and receive data via the communications medium 130. The client application 110 may include any software application or combination of software applications for requesting and/or receiving data via the communications medium 130. In the present embodiment, the client application 110 communicates with the file server 115 via the communications medium 130 and retrieves data from the file server 115 describing the availability of file segments on different data storage systems accessible by the file server 115.

In one embodiment, the client application 110 communicates a request to the file server 115 for data describing the availability of particular file segments residing within various data storage systems accessible by the file server 115. The request may contain the name of a particular file or files, a category of files, a content hash of a file or files, sizes of particular files, a list of specific file segments of a file or files, or other information that identifies a file or files or segments of a file or files. In response, the client application 110 receives data from the file server 115. Based upon the data received from the file server 115, the client application 110 may retrieve particular files or file segments from the file server 115.

The client application 110 may also or alternatively communicate with the p2p network 120 to retrieve segments of a file. The client application 110 transmits requests for particular segments of a file to one or more p2p clients 125 via the p2p network 120. In response, the p2p clients 125 transmit the requested file segment to the client 105. In the present embodiment, the client 105 operates as one of the p2p clients 125 in the p2p network 120. In one exemplary embodiment, the client application 110 communicates with clients of the p2p network 120 using BitTorrent technology to retrieve file segments of a particular file.

The communications medium 135 may be any medium for transferring information. For example, the communications medium 135 may be the Internet or other network, such as a local area network. In the present embodiment, the communications medium 130 includes the p2p network 120. The p2p network 120 includes multiple clients 125 configured to exchange information, such as a multiple computers that use the BitTorrent protocol to distribute digital files. The p2p network 120 may, however, include a network of computers using alternative systems for communicating and distributing files among peers. The p2p network 120 communicates with the client 105 and other p2p clients 125 such that the client 105 may retrieve file segments from the p2p network 120. Any appropriate system and device may be connected to the p2p network 120, such as computers, telephones, personal media players, entertainment systems, data sources, and servers.

The data embodied within the file segments that are communicated via the communications medium 130 between the client 105, p2p clients 125, and/or file server 115 may include any data communicable via the communications medium 130. For example, the data may comprise segments of a single digital file or collection of files that may include video files, music files, or other collections of digital information. Alternatively, the data may be a stream of data embodying a video or music broadcast. The stream may be a quasi-continuous flow of data made available via the communications medium 130 and may be distributed by the p2p network 120, the clients 125, and the file server 115. In an alternate embodiment, the data may comprise analog information that may be distributed via the communications medium 125, for example comprising an analog video or music broadcast.

The data transfer system 100 for retrieving content may include several p2p clients 125 connected to the communications medium 130 and configured to communicate with the client 105, p2p network 120, other p2p clients 125, and/or the file server 115. The p2p clients 120 may comprise any device capable of communication via the communications medium 130. In the present embodiment, the p2p clients 125 are conventional computers having a processor and a storage mechanism, such as RAM, hard drives, CD-ROM drives and disks, HD-DVD drives and disks, or other appropriate volatile or non-volatile memory system. Alternatively, the p2p clients 125 may comprise televisions, stereos, radios, PDA, personal media player, telephones, or other devices that receive digital or analog data.

The p2p clients 125 may execute software applications for requesting and/or providing information to and from other p2p clients 125 and the client 105 via the communications medium 130. For example, the p2p clients 125 may be conventional computer systems executing software and connected to the network. The p2p clients 125 may connect to the network in any manner, including a network cable connection or a wireless connection. Also, the p2p clients 125 may communicate through the network using any appropriate communication protocols, such as TCP/IP, UDP, etc. In the present embodiment, the p2p clients 125 execute p2p network software for communicating and transferring information between the p2p clients 125 and the client 105. For example, the p2p clients 125 may be configured to execute BitTorrent client software and to communicate using BitTorrent protocols.

The p2p network 120 may include any other elements for operation. For example, the present p2p network 120 includes a p2p file info server 135 connected to the communications medium 130 and configured to communicate with the client 105, the clients 125, the file serer 115, and/or other elements of the data transfer system 100. The p2p file info server 135 may include one or more conventional computers having a processor and a storage mechanism or applications running on such computers that communicate with the client 105 and/or p2p clients 125 through the communications medium 130.

The p2p file info server 135 is configured to transmit data to the client 105 or p2p clients 125 that identify a particular file. The data transmitted by the p2p file info server 135 may describe a file to be retrieved by the client 105 and provide data that allows the client application 110 to retrieve the contents of the file from the p2p network 120 and p2p clients 125 or the file server 115. For example, the data may contain the IP addresses of both the file server 115 and one or more trackers that are responsible for maintaining a list of p2p clients 125 that are currently distributing the file. The data provided by the p2p file info server 135 may also contain information such as the size of the file, a SHA hash of the file's contents, etc. In one embodiment, for example, the data distributed by the p2p file info server 135 includes a torrent file that further contains information allowing the client application 110 to communicate and retrieve data from the file server 115 via a BitTorrent p2p network.

The file server 115 is connected to the communications medium 130 and is capable of communicating via the medium 130 with the client 105. The present embodiment includes one or more file servers 115 that may operate as data sources and provide other appropriate functions. The file server 115 may include any data source configured to communicate via the communications medium 130. For example, the file server 115 may include hardware, software, and/or networking components configured to receive and process requests from the client 105 and/or client application 110 and provide a website or other Internet-based interface accessible by die client 105 and the client application 110. In one embodiment, the file server 115 is a computer running an operating system (i.e. MS Windows, Mac OSX, Linux, etc.) and a web server (i.e. Apache, etc.). In an alternate embodiment, the file server 115 may also store information that describes the file to be delivered to the client 105, for example by providing the functionality of the p2p file info server 135.

The file server 115 transmits file segments of the file to the client 105 via the communication medium 130. The file segments include segments of the file to be transmitted to the client 105 and may be created by any method. For example, the file server may transmit file segments that are created using a substantially similar method as the p2p clients 125 employ to split a particular file into file segments. Alternatively, the file server 115 may use a different method of splitting the file into file segments. For example, the size of the file segments may be modified based on a determination of the computing power of either the file server 115 or the client 105 and the network bandwidth of the communication medium 130 connecting the client 105 and the file server 115. The file server 115 is capable of transmitting a particular file segment in response to a request for the file segment from the client application 110.

The file server 115 may be connected to at least one data storage system. The data storage systems may include, for example, primary, secondary, tertiary and network data storage systems. Such systems may include traditional data storage mechanisms such as RAM memory, hard drives, CD, DVD and HD-DVD drives, flash memory drives, tape drives, remote or local databases, and network file systems. Alternatively, the data storage system may include alternative systems from which the file server 115 can retrieve data. For example, the data storage systems may further include p2p networks, digital video recorders, digital cameras, digital music players, personal digital assistants, personal media players, etc. accessible by the file server 115.

In the present embodiment, the file server 115 runs server software 140 that catalogs the data stored by at least one of the data storage systems and transmits at least a portion of the catalog to the client 105. For example, the server software 140 may inspect the file server's 115 RAM to catalog the files or file segments that are currently stored within RAM. The server software 140 may then transmit the identity of those files or file segments to the client 105. Alternatively, the server software 140 may inspect two or more data storage systems to catalog the file segments that are available on each of the system. The server software 140 may then communicate the catalog to the client 105.

The data transmitted by the server software 140 to the client 105 may be limited by any criteria. For example, the server software 140 may only perform the cataloging activity for one particular file or category of files, for example music or video files. The server software 140 may also generate performance data reflecting the access and data transfer times for each of the file segments residing on the various data storage systems, which may then be reflected in the catalog. The performance data is then transmitted to the client 105. Furthermore, the catalog may be limited to data for particular segments of a file. The catalog may contain additional information such as the identity of other file servers 115 that have access to the requested file or file segments, hashes of available data and lists of other available files.

In one exemplary embodiment, the server software 140 generates a catalog of file segments and their storage locations for a particular file or category of files. The catalog may then be published via any interface or mechanism available to the file server 115. For example, the data may be published via a web server or other server that can be accessed by the client application 110.

In an alternate embodiment, the file server 115 transmits the catalog in response to a request from the client 105. The request may be for data describing the availability on particular data storage systems of particular file segments of specific files, file segments or categories of files stored on data storage systems accessible by the file server 115. After cataloging the results, they may be transmitted to the client 105.

In some embodiments, the data generated by the server software 140 may be stored in a database and continuously updated by the server software 140. In response to a request from the client 105, the server software 140 may then inspect the database for data relating to the client's 105 request. Upon retrieving the data from the database, it may be transmitted to the client 105 by the server software 140.

In operation, the client 105 requests files for download from the server 115 and the other elements of the data transfer system 100. The client 105 may request the files according to any appropriate criteria or process, such as initially referring to a catalog of file segments available on the server 115, requesting files directly from the server 115, or sending one or more request to the server 115 and the other elements of the p2p network 120 to get the files. In response, the server 115 may attempt to fulfill the request according to appropriate parameters. For example, the server 115 may seek the file segments only in selected portions of its memory or in conjunction with a database of readily available file segments. The server 115 may also respond with a list of file segments available, and the client 105 may then select which file segments to request from the server 115. The remaining file segments may be requested from other sources, such as the other p2p clients 125, for example before, concurrently with, or after requesting file segments from the server 115.

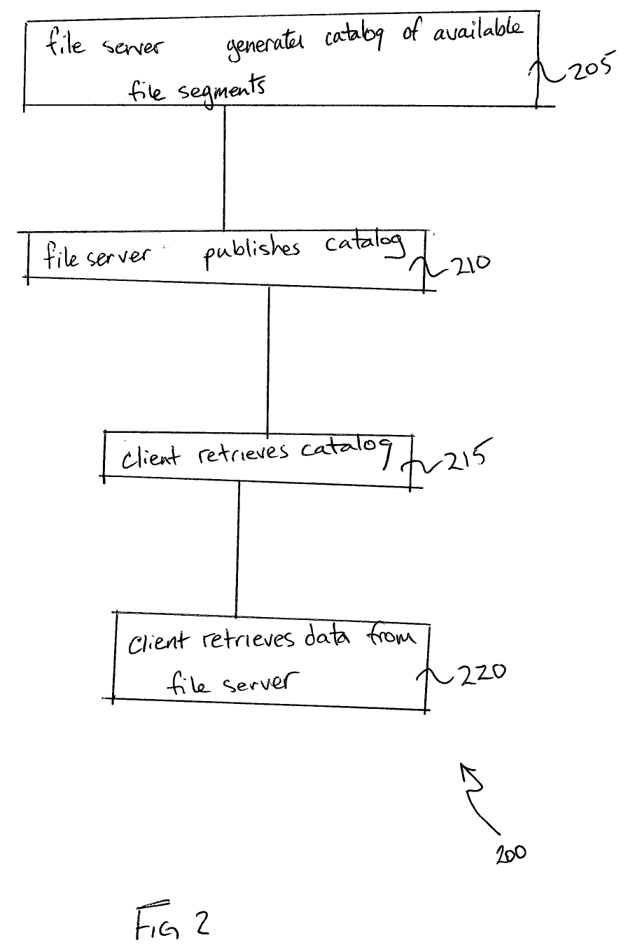

For example, the client 105 may initially have access to the catalog generated by the file server 115. In one embodiment, referring to FIG. 2, the file server 115 may generate the catalog identifying files and file segments available from the server 115 and/or the availability of files and file segments on particular data storage devices (205). The catalog may be generated based upon any criteria. For example, the catalog may only contain data for particular data storage devices, such as data for those files or file segments stored in quick-access data storage systems. The catalog may also be limited to particular files, categories of file, or particular file segments. For example, the catalog may only be generated for media files, or for non-system files. The catalog may also be limited to files containing data from particular databases, files that are in particular directories or folders, and/or files relating to particular services or server functions. The catalog may also contain additional data generated by the server software 140, such as data corresponding to access and data transfer performance characteristics for data residing on each data storage device.

After generating the catalog, the server software 140 may publish the catalog for use by the client 105 (210). After the catalog is published, it may be transmitted to or retrieved by the client 105 (215). For example, the catalog may be published as a web-page via a web server. Alternatively, the data may be published by other software applications that communicate with the client 105 via the communications medium 130. In an alternate embodiment, only a portion of the catalog is made available to the client 105. For example, the data describing data storage locations for system files may not be published in the catalog. The client 105 may then use the catalog information to request files or file segments (220).

After the catalog has been initially generated, it may be updated by the server software 140. The catalog may only be updated sporadically, or the catalog may be continuously updated to provide the client 105 with relatively up-to-date information regarding the current storage locations, availability, and/or other relevant information for particular files or file segments.

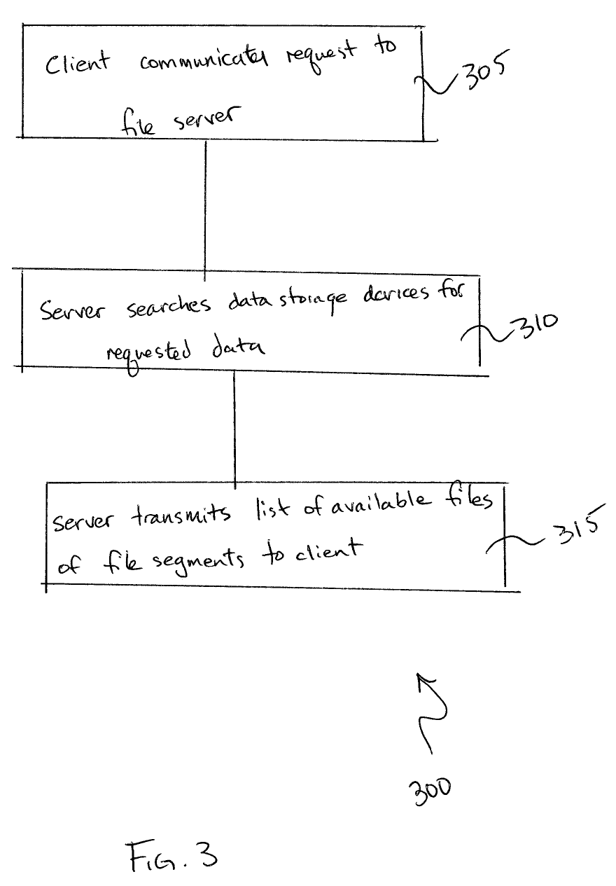

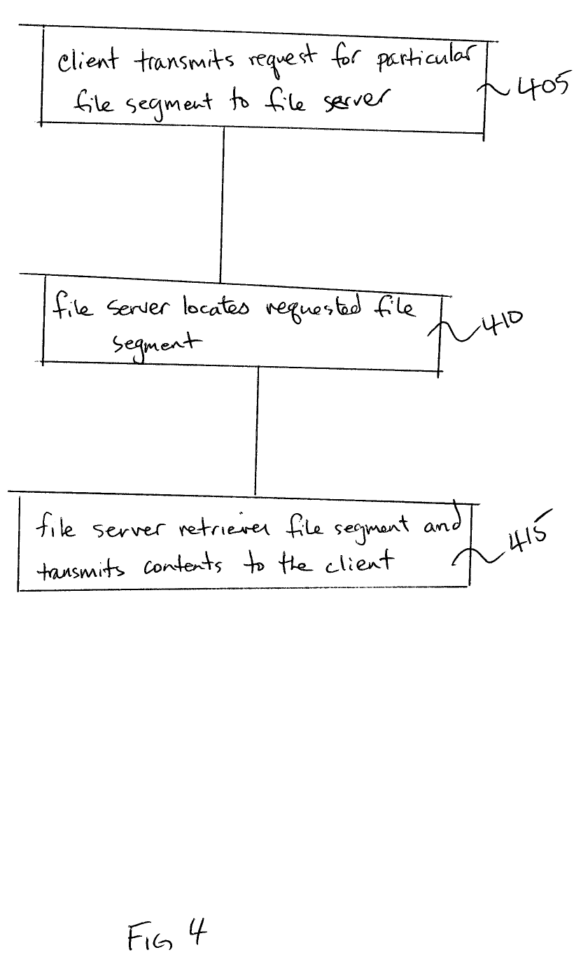

Referring to FIGS. 3 and 4, to obtain files, the client 105 generates a request. The request may be directed to one or more possible sources for the file, concurrently or successively. For example, the client application 110 may initially contact the file info server 135 to request information regarding which servers 115 have the relevant file segments or trackers that can identify p2p clients 125 that have the relevant file segments. The client application 110 may then contact those servers 115 and/or p2p clients 125 to request the files.

Alternatively, the client application 110 may initially refer to the catalog provided, by the server 115, if one is available, to identify files or file segments that are available from the server 115, or otherwise initially contact the file server 115. For example, the client application 110 may refer to the version of the catalog received from the server 115, or may access the server 115 to retrieve a copy of the catalog, such as via a web page provided by the file server 115. If the relevant files or segments are available according to the catalog, the client application 110 may request the files or segments directly from the server 115 (305, 405). Thus, client application 110 may initially download those files or file segments that are quickly available from the file server 115, such as files and segments stored in the server's RAM or cache. If no catalog is available, the client 105 may request all relevant files or segments from the server 115. Files and segments that are not readily available, or available at all, from the server 115 may be requested from the other elements of the p2p network 120.

The request may comprise any relevant information. For example, the request may contain the name of a file, a description of the file, a hash of the file's contents, the file size, a list defining one or more requested file segments, and any other information that may identify the file or file segments requested by the client 105.

Upon receiving the request, the file server 115 may respond, for example by providing readily available files and/or segments, or a list of readily available files and/or segments. In one embodiment, the file server 115 transmits those file segments to the client 105 that are available on data storage systems that satisfy particular requirements. For example, in response to a request for a list of file segments, the file server 115 may only transmit to the client 105 those file segments that are readily available from the file server 115, such as segments currently available on a primary data storage system like the file server's 115 RAM. In an alternative embodiment, the file server 115 may elect to respond to a request from the client 105 by simply transmitting to the client 105 any available data that falls within the requested criteria. In such an embodiment, the file server 115 may further transmit data to the client 105 that indicates which files or file segments are unavailable.

Referring to FIG. 4, in one embodiment, the file server 115 may locate the file segment on an approved accessible data storage device (410). For example, the file server 115 may only search for the file segment in primary memory systems. The file segment may then be retrieved from the data storage device and transmitted to the client 105 (415). If the file segment is not found on an approved accessible data storage device, the file server 115 may communicate a message to the client 105 indicating the file is not available.

In an alternative embodiment, the file server 115 may only search a subset of available data storage devices to determine whether the requested file segment is available. For example, the search may be limited to only primary and secondary storage devices. Accordingly, even if the file segment is located on a long term storage device such as a tertiary or network storage devices, the file server 115 responds to the request with an indication that the file segment is unavailable.

Referring to FIG. 3, the file server 115 may alternatively respond by performing a search or consulting a database to determine whether the requested files or file segments are available and in which data storage device they are currently stored (310). The file server 115 may then transmit a list of available files or file segments and their current storage locations to the client 105 (315). Furthermore, the file server 115 may transmit additional data generated by the server software 140, such as performance data. Upon receiving the data, the client 105 may contact the file server 115 to request a particular file or file segment, in which case the data comprising the file or file segments may be transmitted to the client 105.

In the foregoing specification, the invention has been described with reference to specific exemplary embodiments. Various modifications and changes may be made without departing from the scope of the present invention as set forth in the exemplary embodiments. The specification and figures are to be regarded in an illustrative manner, rather than a restrictive one and all such modifications may be included within the scope of the present invention. For example, the steps recited in any method or process embodiments may be executed in any appropriate order and are not limited to the specific order presented in the embodiments. Additionally, the components and/or elements recited in any apparatus embodiment may be otherwise assembled or operationally configured to produce substantially the same result and are accordingly not limited to the specific configurations recited in the embodiments.

Various benefits, advantages, and solutions to problems have been described with regard to particular embodiments. Any benefit, advantage, solution to problems or any element that may cause any particular benefit, advantage, or solution to occur or to become more pronounced are not to be construed as critical, required, or essential features or components of any or all the embodiments.

Furthermore, the terms ‘first’, ‘second’, and the like herein, if any, are used for distinguishing between similar elements and not necessarily for describing a sequential or chronological order. Moreover, the terms ‘front’, ‘back’, ‘top’, ‘bottom’, ‘over’, ‘under’, and the like in the disclosure and/or in the provisional embodiments, if any, are generally employed for descriptive purposes and not necessarily for comprehensively describing exclusive relative position. Any of the preceding terms so used may be interchanged under appropriate circumstances such that various embodiments of the invention, for example, are capable of operation in other configurations and/or orientations than those explicitly illustrated or otherwise described.

The terms “comprises”, “comprising”, “including”, or any variation thereof, are intended to reference a non-exclusive inclusion, such that a process, method, article, composition, or apparatus that comprises one or more elements does not include only the elements recited, but may also include other elements not expressly listed or inherent to such process, method, article, composition or apparatus. Other combinations and/or modifications of the described structures, arrangements, applications, proportions, elements, materials, or components used in the practice of the present invention, in addition to those not specifically recited, may be varied or otherwise particularly adapted to specific environments, manufacturing specifications, design parameters, or other operating requirements without departing from the general principles of the disclosed invention.

1-17. (canceled)

18. A method for transferring data in a p2p network connecting a plurality of clients, comprising:
generating a catalog of multiple file segments stored in a memory accessible by a file server; and
publishing the catalog for access by the clients.

19. A method for transferring data according to claim 18, wherein the catalog includes performance data relating to transferring at least one of the file segments.

20. A method for transferring data according to claim 19, wherein the performance data includes information relating to an access time for at least one of the file segments.

21. A method for transferring data according to claim 19, wherein the performance data includes information relating to at least one of a transfer rate and a transfer speed for at least one of the file segments.

22. A method for transferring data according to claim 18, wherein:
the multiple file segments arc stored in multiple types of memory; and
the catalog includes information relating to the types of memory in which the multiple file segments are stored.

23. A method for transferring data according to claim 18, wherein publishing the catalog comprises:
receiving a request for the catalog from a client; and
transmitting the catalog to the requesting client.

24. A method for transferring data according to claim 18, further comprising:
receiving a request for one or more selected file segments identified in the catalog from a requesting client; and
transmitting the one or more selected file segments to the requesting client.

25. A computer adapted to transfer data in a p2p network connecting a plurality of clients, comprising:
a plurality of memory devices storing multiple file segments; and
a processor in communication with the memory devices, wherein the processor is adapted to:
generate a catalog of the multiple file segments stored in the memory devices; and
publish the catalog for access by the clients.

26. A computer adapted to transfer data according to claim 25, wherein the catalog includes performance data relating to transferring at least one of the file segments.

27. A computer adapted to transfer data according to claim 26, wherein the performance data includes information relating to an access time for at least one of the file segments.

28. A computer adapted to transfer data according to claim 26, wherein the performance data includes information relating to at least one of a transfer rate and a transfer speed for at least one of the file segments.

29. A computer adapted to transfer data according to claim 25, wherein:
the memory devices comprise multiple types of memory devices; and
the catalog includes information relating to the types of memory devices in which the multiple file segments are stored.

30. A computer adapted to transfer data according to claim 25, wherein the processor is adaped to:
receive a request for the catalog from a client; and
transmit the catalog to the requesting client.

31. A computer adapted to transfer data according to claim 25, wherein the processor is adaped to:
receive a request for one or more selected file segments from a requesting client; and
transmit the one or more selected file segments to the requesting client.

32. A computer program for executing on a computer system a computer process for transferring data in a p2p network connecting a plurality of clients, the computer process comprising:
generating a catalog of multiple file segments stored in a memory accessible by a file server; and
publishing the catalog for access by the clients.

33. A computer program according to claim 32, wherein the catalog includes performance data relating to transferring at least one of the file segments.

34. A computer program according to claim 33, wherein the performance data includes information relating to an access time for at least one of the file segments.

35. A computer program according to claim 33, wherein the performance data includes information relating to at least one of a transfer rate and a transfer speed for at least one of the file segments.

36. A computer program according to claim 32, wherein:
the multiple file segments are stored in multiple types of memory; and
the catalog includes information relating to the types of memory in which the multiple file segments are stored.

37. A computer program according to claim 32, wherein publishing the catalog comprises:
receiving a request for the catalog from a client; and
transmitting the catalog to the requesting client.

38. A computer program according to claim 32, further comprising:
receiving a request for one or more selected file segments from a requesting client; and
transmitting the one or more selected file segments to the requesting client.
